(19) United States
(12) Patent Application Publication
(10) Pub. No.: US 2020/0077843 A1
(43) Pub. Date: Mar. 12, 2020

(54) Electrothermal Ice Cream Scoop Device

(71) Applicant: Yee Ting NAM, Hong Kong (HK)

(72) Inventor: Yee Ting NAM, Hong Kong (HK)

(21) Appl. No.: 16/205,167

(22) Filed: Nov. 29, 2018

(30) Foreign Application Priority Data
Sep. 7, 2018 (CN) 201811040880.X

(51) Int. Cl. A47J 43/28; A47J 45/08

(52) U.S. Cl. CPC A47J 43/282; A47J 45/08

(57) ABSTRACT

The invention relates to an electrothermal ice cream scoop device which includes a handle, an excavating mechanism, an anti-sticking mechanism and a smear mechanism. The handle includes a shell with a hollow structure, a controller, a battery and an end cap. The excavating mechanism includes a scooping spoon, a connecting tube, an electric heating mechanism, and a heating insulating mechanism. The anti-sticking mechanism includes a scraper, a rotating shaft, a helical gear, a rotating wheel and a motor. The smear mechanism includes a control valve and a delivery tube. The device of the present invention has simple and reasonable structure, ease to use, and high degree of intelligence, etc. Ice cream can be easily dug and fall off from the ice cream scoop. It effectively solves the problem of poor effect of traditional ice cream scoops.

### FIELD OF THE INVENTION

The invention relates to intelligent home equipment. In particular, the invention relates to an electrothermal ice cream scoop device.

### BACKGROUND

In the prior art, traditional ice cream scoop is composed of a spoon body and a grip. The ice cream usually becomes very hard after a long time of refrigerating, so that the ordinary ice cream scoop can only be used to dig the hard ice cream bit by bit. Or a long time is spent in waiting for the ice cream to melt slightly before digging. Usually, after the ice cream is dug, the ice cream itself has a certain viscosity, and the water between the ice cream and the ice cream spoon will freeze, thus the ice cream does not easily fall off the ice cream scoop, which makes it very troublesome to take ice cream. When eating ice cream, it is usually added with jam and other excipients to increase the flavor. However, the excipients can only be added after the ice cream is taken out, which is inconvenient.

### SUMMARY OF THE INVENTION

The technical problem to be solved is to overcome the above-mentioned deficiency by providing an electrothermal ice cream scoop device. The device has simple and reasonable structure, ease to use, and high degree of intelligence, etc. Ice cream can be easily dug and fall off from the ice cream scoop. It effectively solves the problem of poor effect of traditional ice cream scoops.

The technical solution of the present invention is to provide an electrothermal ice cream scoop device which includes a handle, an excavating mechanism, an anti-sticking mechanism and a smear mechanism. The handle includes a shell with a hollow structure, a controller, a battery, and an end cap.

The tail portion of the shell is provided with a seasoning chamber for holding the seasoning. The seasoning chamber is provided with a push plate, a telescopic push rod and a first spring. The two ends of the telescopic push rod are fixedly connected with the push plate and the end cap respectively. The first spring is sleeved on the telescopic push rod, and the two ends of the first spring are fixedly connected to the push plate and the end cap respectively. The controller and the battery are fixedly disposed in a cavity of the front end of the shell.

The excavating mechanism includes a scooping spoon, a connecting tube, an electric heating mechanism and a heat insulating mechanism. The scooping spoon is fixedly connected with the front end of the shell through the connecting tube, and penetrates into the cavity at the front end of the shell. An electric heating mechanism with annular structure is sleeved on the connecting tube penetrating into the cavity at the front end of the shell. A heat insulating mechanism having a sheet structure is fixedly disposed between the electric heating mechanism and the shell.

The anti-sticking mechanism includes a scraper disposed in the cavity of the scooping spoon, a rotating shaft sleeved in the connecting tube through a bearing, a helical gear, a rotating wheel and a motor. One end of the rotating shaft extends into the cavity of the scooping spoon through a through hole to connect the scraper. The other end of the rotating shaft extends into the cavity of the front end of the shell to connect the helical gear and the motor sequentially. The helical gear is connected to the part of the rotating wheel which extends outward from the shell. The rotating shaft and the scraper have a hollow structure and the scraper is provided with a plurality of discharge ports.

The smear mechanism is disposed in a cavity at the front end of the shell. The smear mechanism includes a control valve and a delivery tube. The control valve includes a valve body having a through groove therein, a valve core having a first through hole, a return spring and a gland partially extending out of the shell. The valve core penetrates into the valve body and is connected to the gland. The valve core between the gland and the valve body surface is sleeved with the return spring. The delivery tube connects to two ends of the through groove to the seasoning chamber and the feed port, respectively.

Further, the first spring is a conical spring, and the larger end of the conical spring is fixedly connected to the push plate.

Further, the edge of the scooping spoon is provided with a blade inclined toward the inner cavity thereof, and the edge thereof is provided with a limiting convex ring extending inwardly.

Further, the rotating shaft of the rotating wheel and the annular buckle in the shell are slidingly connected in the radial direction of the helical gear, and the second spring is arranged in the annular buckle to press the rotating wheel away from the helical gear.

Further, a limiting rod is symmetrically arranged on the rotating shaft, and a limiting protrusion is arranged on the shell.

The technical effect of the present invention is to provide an electrothermal ice cream scoop device which includes a handle, an excavating mechanism, an anti-sticking mechanism and a smear mechanism. The handle and the excavating mechanism are connected to each other. The handle is provided with a seasoning chamber, which the sauce can conveniently be placed in. The excavating mechanism accelerates the excavation speed through the blade design and electric heating, and a controller is provided into the handle to control the temperature, which keeps the excavating mechanism at a certain temperature but controls the temperature not too hot. The anti-sticking mechanism is combined with the smear mechanism, so that the ice cream can be removed from the excavating mechanism by using the anti-sticking mechanism, and the excipients such as jam can be smeared on the ice cream. It is very convenient. The anti-sticking mechanism can be driven by the motor or by the rotating the wheel. In other words, the anti-sticking mechanism and the smear mechanism can be used even in the case of power failure. The device has simple and reasonable structure, ease to use, and high degree of intelligence, etc. Ice cream can be easily dug and fall off from the ice cream scoop. It effectively solves the problem of poor effect of traditional ice cream scoops.

### BRIEF DESCRIPTION OF THE DRAWINGS

The invention is illustrated by the following figures and embodiments.

FIG. 1 shows a schematic diagram of whole structure of an electrothermal ice cream scoop device in accordance with an example embodiment.

FIG. 2 shows a schematic diagram of external structure of an electrothermal ice cream scoop device in accordance with an example embodiment.

FIG. 3 shows a schematic diagram of connection of a scooping spoon and a connecting tube of an electrothermal ice cream scoop device in accordance with an example embodiment.

FIG. 4 shows a schematic diagram of connection of a scraper, a rotating shaft and a helical gear of an electrothermal ice cream scoop device in accordance with an example embodiment.

FIG. 5 shows a schematic diagram of a radial section along the rotating shaft of an electrothermal ice cream scoop device in accordance with an example embodiment.

FIG. 6 shows a schematic diagram of a control valve of an electrothermal ice cream scoop device in accordance with an example embodiment.

The reference numbers of the figures are as follows:

1: handle; 11: shell; 111: limiting protrusion; 12: seasoning chamber; 13: push plate; 14: telescopic push rod; 15: first spring; 16: end cap; 17: battery; 18: controller; 19: second spring; 2: excavating mechanism; 21: scooping spoon; 211: bearing; 212: through hole; 213: blade; 214: limiting convex ring; 22: connecting tube; 23: electric heating mechanism; 24: heating insulating mechanism; 3: anti-sticking mechanism; 31: scraper; 311: discharge port; 32: rotating shaft; 321: feed port; 322: limiting rod; 33: helical gear; 34: rotating wheel; 35: motor; 4: smear mechanism; 41: control valve; 411: valve body; 412: through groove; 413: valve core; 414: first through hole; 415: return spring; 416: gland; 42: delivery tube.

### DETAILED DESCRIPTION

The invention is illustrated in accordance with figures. The figures as simplified diagrams demonstrate the basic structures of the apparatus of embodiments of the invention. Thus, the invention is not limited to the figures.

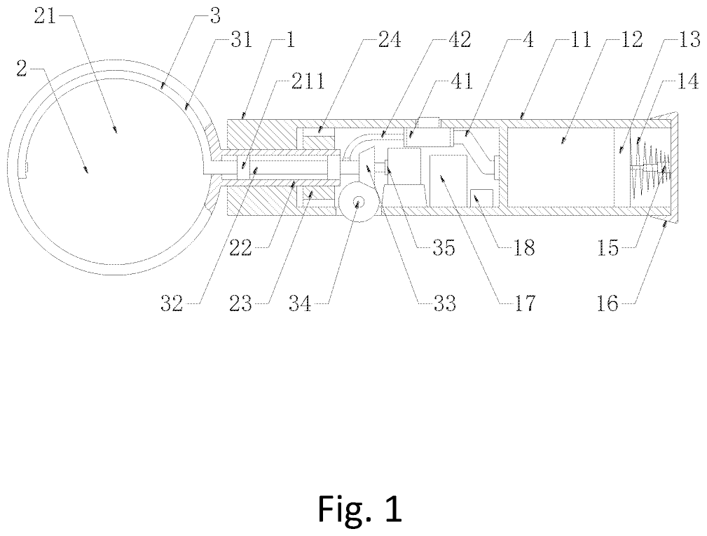

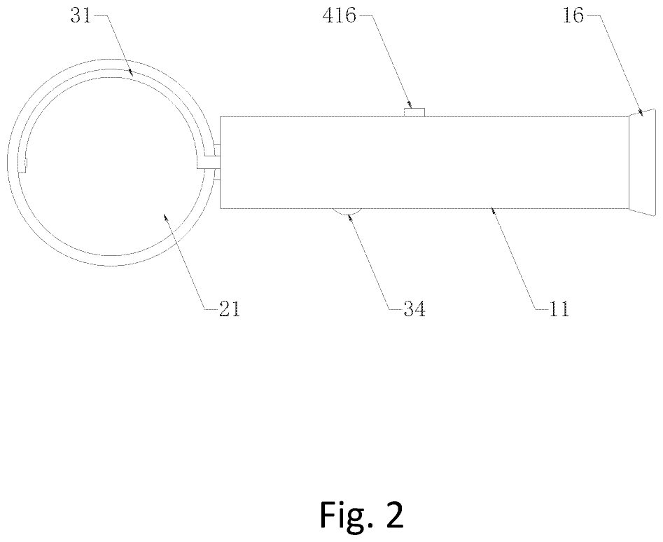

As shown in FIGS. 1 and 2, an electrothermal ice cream scoop device includes a handle 1, an excavating mechanism 2, an anti-sticking mechanism 3 and a smear mechanism 4.

The handle 1 includes a shell 11 with a hollow structure, a controller 18, a battery 17, and an end cap 16.

The tail portion of the shell 11 is provided with a seasoning chamber 12 for holding the seasoning. The seasoning chamber 12 is provided with a push plate 13, a telescopic push rod 14 and a first spring 15. The two ends of the telescopic push rod 14 are fixedly connected with the push plate 13 and the end cap 16 respectively. The first spring 15 is sleeved on the telescopic push rod 14, and the two ends of the first spring 15 are fixedly connected to the push plate 13 and the end cap 16 respectively. By using this structure, a certain pushing force can be provided to the fluid-like seasoning such as paste or liquid which are contained in the seasoning chamber 12.

In an example embodiment, when the seasoning chamber 12 is used to store small particles and seasoning which is not easily adhered to each other, the push plate 13, the telescopic push rod 14, and the first spring 15 are not disposed therein.

The controller 18 and the battery 17 are fixedly disposed in a cavity of the front end of the shell 11. The controller 18 is used to control the operation of the components of the present invention. The sensor, the electric component, the power source (including the external power source and the battery of the embodiment of the present invention, are connected thereto, and through buttons, touch screen or external devices provided on the shell 11, to control the operation of the controller 18 by sending control commands. In order to prevent the cavity at the front end of the housing 11 from contaminating the seasoning chamber 12, the cavity and the chamber are completely blocked.

The excavating mechanism 2 includes a scooping spoon 21, a connecting tube 22, an electric heating mechanism 23 and a heat insulating mechanism 24. The scooping spoon 21 is fixedly connected with the front end of the shell 11 through the connecting tube 22, and penetrates into the cavity at the front end of the shell 11. An electric heating mechanism 23 with annular structure is sleeved on the connecting tube 22 penetrating into the cavity at the front end of the shell 11. For example, electric and heating mechanism is made of electric heating coil or other electrothermal material (such as carbon fiber). A heat insulating mechanism 24 having a sheet structure is fixedly disposed between the electric heating mechanism 23 and the shell 11.

In order to avoid the danger of excessive temperature, or the low temperature which affects the speed of digging the ice cream, a temperature sensor connected to the controller 18 is provided on the connecting tube 22 to monitor the temperature of the connecting tube 22 in real time.

The anti-sticking mechanism 3 includes a scraper 31 disposed in the cavity of the scooping spoon 21, a rotating shaft 32 sleeved in the connecting tube 22 through a bearing 211, a helical gear 33, a rotating wheel 34 and a motor 35. One end of the rotating shaft 32 extends into the cavity of the scooping spoon 21 through a through hole 212 to connect the scraper 31. The other end of the rotating shaft 32 extends into the cavity of the front end of the shell 11 to connect the helical gear 33 and the motor 35 sequentially. The helical gear 33 is connected to the part of the rotating wheel 34 which extends outward from the shell 11. In other words, the motor 35 and the rotating wheel 34 can both drive the rotation of the rotating shaft 32. The scraper 31 and the cavity of the scooping spoon 21 attach closely to each other. In an example embodiment, one end of the scraper 31 away from the rotating shaft 32 is hinged to the scooping spoon 21.

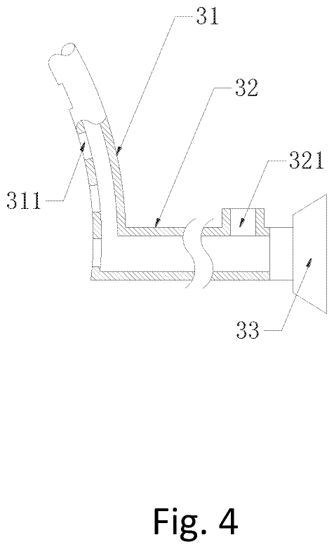

As shown in FIG. 4, the rotating shaft 32 and the scraper 31 have a hollow structure and the scraper 31 is provided with a plurality of discharge ports 311.

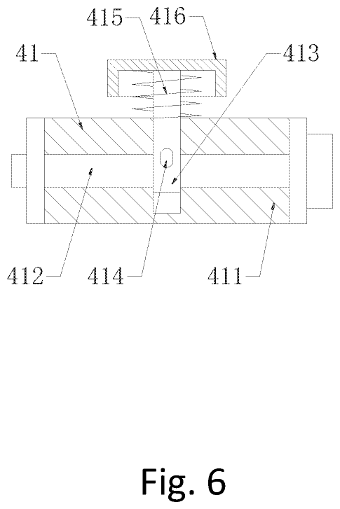

As shown in FIGS. 1 and 6, the smear mechanism 4 is disposed in a cavity at the front end of the shell 11. The smear mechanism 4 includes a control valve 41 and a delivery tube 42.

The control valve 41 includes a valve body 411 having a through groove 412 therein, a valve core 413 having a first through hole 414, a return spring 415 and a gland 416 partially extending out of the shell 11. The valve core 413 penetrates into the valve body 411 and is connected to the gland 416. The valve core 413 between the gland 416 and the valve body 411 surface is sleeved with the return spring 415. The delivery tube 42, a flexible tube, connects to two ends of the through groove 412 to the seasoning chamber 12 and the feed port 321 of the rotating shaft 32, respectively.

The seasoning in the seasoning chamber 12 is transported to the surface of the ice cream through the delivery tube 42, the control valve 41, the rotating shaft 32, and the discharge port 311. When the seasoning has fluidity, the push plate 13, the telescopic push rod 14, and the first spring 15 provide the pressing force to cause it to move toward the discharge port 311. When the seasoning is pellets, gravity causes it to move toward the surface of the ice cream.

In an example of FIG. 1, in order to increase the capacity in the seasoning chamber 12, the space occupied by the first spring 15 after compression is reduced. The first spring 15 is a conical spring, to stabilize the push plate 13 so that the push plate 13 does not swing when pushing the seasoning. The end of the larger radius of the spring is fixedly connected to the push plate 13, and of course, a general cylindrical spring can also be used.

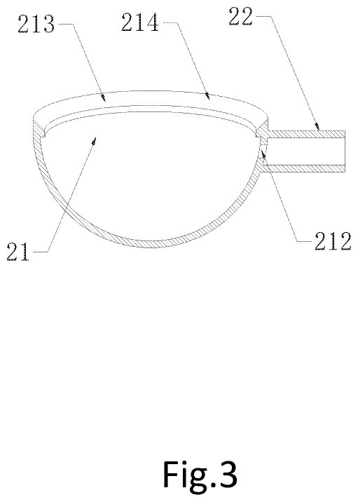

In an example of FIG. 3, the edge of the scooping spoon 21 is provided with a blade 213 inclined toward the inner cavity thereof, and the edge thereof is provided with a limiting convex ring 214 extending inwardly. The scraper 31 is prevented from being deformed by the ice cream ball as the ice cream ball is detached from the scooping spoon 21.

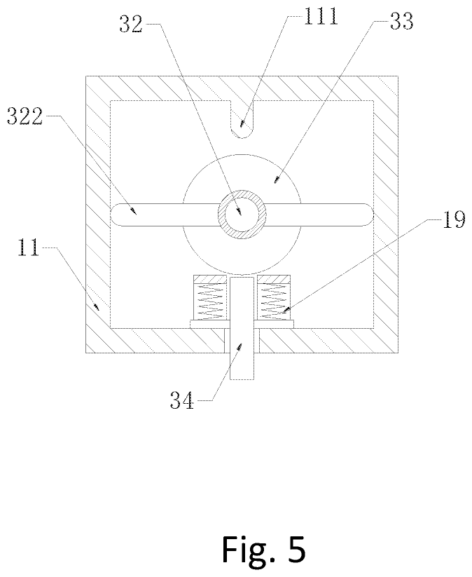

In an example of FIG. 5, the rotating shaft of the rotating wheel 34 and the annular buckle (n-shaped structure) in the shell 11 are slidingly connected in the radial direction of the helical gear 33, and the second spring 19 is arranged in the annular buckle to press the rotating wheel 34 away from the helical gear 33. When the motor 35 is used to drive the rotating shaft 32, the rotating wheel 34 is not driven, and when the rotating shaft 32 is driven by the rotating wheel 34, the rotating wheel 34 is pressed inward and rotated.

In an example of FIG. 5, a limiting rod 322 is symmetrically arranged on the rotating shaft 32, and a limiting protrusion 111 is arranged on the shell 11. In order that the delivery tube 42 is not bent and blocked due to the excessive rotation angle of the rotating shaft 32, it is necessary to limit the angle of rotation thereof. For this purpose, an angle sensor connected to the controller 18 is also provided on the rotating shaft 32.

An electrothermal ice cream scoop device of the present invention has a reasonable structure. The device includes a handle, an excavating mechanism, an anti-sticking mechanism and a smear mechanism. The handle and the excavating mechanism are connected to each other. The handle is provided with a seasoning chamber, which the sauce can conveniently be placed in. The excavating mechanism accelerates the excavation speed through the blade design and electric heating, and a controller is provided into the handle to control the temperature, which keeps the excavating mechanism at a certain temperature but controls the temperature not too hot. The anti-sticking mechanism is combined with the smear mechanism, so that the ice cream can be removed from the excavating mechanism by using the anti-sticking mechanism, and the excipients such as jam can be smeared on the ice cream. It is very convenient. The anti-sticking mechanism can be driven by the motor or by the rotating the wheel. In other words, the anti-sticking mechanism and the smear mechanism can be used even in the case of power failure. The device has simple and reasonable structure, ease to use, and high degree of intelligence, etc. Ice cream can be easily dug and fall off from the ice cream scoop. It effectively solves the problem of poor effect of traditional ice cream scoops.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

What is claimed is:

1. An electrothermal ice cream scoop device, comprising a handle 1, an excavating mechanism 2, an anti-sticking mechanism 3 and a smear mechanism 4, wherein the handle 1 includes a shell 11 with a hollow structure, a controller 18, a battery 17, and an end cap 16,
wherein the tail portion of the shell 11 is provided with a seasoning chamber 12 for holding the seasoning; the seasoning chamber 12 is provided with a push plate 13, a telescopic push rod 14 and a first spring 15; the two ends of the telescopic push rod 14 are fixedly connected with the push plate 13 and the end cap 16 respectively; the first spring 15 is sleeved on the telescopic push rod 14, and the two ends of the first spring 15 are fixedly connected to the push plate 13 and the end cap 16 respectively; the controller 18 and the battery 17 are fixedly disposed in a cavity of the front end of the shell 11,
wherein the excavating mechanism 2 includes a scooping spoon 21, a connecting tube 22, an electric heating mechanism 23 and a heat insulating mechanism 24; the scooping spoon 21 is fixedly connected with the front end of the shell 11 through the connecting tube 22, and penetrates into the cavity at the front end of the shell 11; an electric heating mechanism 23 with annular structure is sleeved on the connecting tube 22 penetrating into the cavity at the front end of the shell 11; a heat insulating mechanism 24 having a sheet structure is fixedly disposed between the electric heating mechanism 23 and the shell 11,
wherein the anti-sticking mechanism 3 includes a scraper 31 disposed in the cavity of the scooping spoon 21, a rotating shaft 32 sleeved in the connecting tube 22 through a bearing 211, a helical gear 33, a rotating wheel 34 and a motor 35; one end of the rotating shaft 32 extends into the cavity of the scooping spoon 21 through a through hole 212 to connect the scraper 31; the other end of the rotating shaft 32 extends into the cavity of the front end of the shell 11 to connect the helical gear 33 and the motor 35 sequentially; the helical gear 33 is connected to the part of the rotating wheel 34 which extends outward from the shell 11; the rotating shaft 32 and the scraper 31 have a hollow structure and the scraper 31 is provided with a plurality of discharge ports 311,
wherein the smear mechanism 4 is disposed in a cavity at the front end of the shell 11; the smear mechanism 4 includes a control valve 41 and a delivery tube 42; the control valve 41 includes a valve body 411 having a through groove 412 therein, a valve core 413 having a first through hole 414, a return spring 415 and a gland 416 partially extending out of the shell 11; the valve core 413 penetrates into the valve body 411 and is connected to the gland 416; the valve core 413 between the gland 416 and the valve body 411 surface is sleeved with the return spring 415; the delivery tube 42 connects to two ends of the through groove 412 to the seasoning chamber 12 and the feed port 321 of the rotating shaft 32, respectively.

2. The electrothermal ice cream scoop device of claim 1, wherein the first spring 15 is a conical spring, and the larger end of the conical spring is fixedly connected to the push plate 13.

3. The electrothermal ice cream scoop device of claim 1, wherein the edge of the scooping spoon 21 is provided with a blade 213 inclined toward the inner cavity thereof, and the edge thereof is provided with a limiting convex ring 214 extending inwardly.

4. The electrothermal ice cream scoop device of claim 1, wherein the rotating shaft of the rotating wheel 34 and the annular buckle in the shell 11 are slidingly connected in the radial direction of the helical gear 33, and the second spring 19 is arranged in the annular buckle to press the rotating wheel 34 away from the helical gear 33.

5. The electrothermal ice cream scoop device of claim 1, wherein a limiting rod 322 is symmetrically arranged on the rotating shaft 32, and a limiting protrusion 111 is arranged on the shell 11.
